(19) United States
(12) Patent Application Publication
(10) Pub. No.: US 2008/0206471 A1
(43) Pub. Date: Aug. 28, 2008

(54) Paint compositions and coating film forming method

(75) Inventors: Yasuhiro Tomizaki, Hiratsuka-shi (JP); Takuya Kawachi, Hiratsuka-shi (JP); Kojiro Kadowaki, Hiratsuka-shi (JP)

Correspondence Address: WENDEROTH, LIND & PONACK, L.L.P., 2033 K STREET N. W., SUITE 800, WASHINGTON, DC, 20006-1021, US

(73) Assignee: KANSAI PAINT CO., LTD.

(21) Appl. No.: 12/071,868

(22) Filed: Feb. 27, 2008

(30) Foreign Application Priority Data
Feb. 27, 2007 (JP) 2007-46772

(51) Int. Cl. C08L 63/00; B05D 1/36

(52) U.S. Cl. 427/407.1; 525/403; 525/408; 525/404

(57) ABSTRACT

This invention provides coating compositions excelling in storage stability and curability, which comprise carboxyl group- and/or cyclic acid anhydride group-containing compound; polyepoxide; and latent curing catalyst composed of tertiary amine and acidic phosphoric acid ester.

### TECHNICAL FIELD

This invention relates to novel compositions excelling in coating film performance such as curability and storage stability, and electrostatic coatability, and also to coating film-forming methods using the compositions.

### BACKGROUND ART

Paints which are to be coated on such objects as automobile bodies are required to form coating films excelling in performance such as finished appearance, acid-resistance and the like.

As paints forming highly acid-resistant coating films, crosslinking type paints whose functional groups are combination of carboxyl group/epoxy group, or carboxyl group/epoxy group/hydroxyl group were reported in the past (for example, see JP Sho 62 (1987)-87288A, JP Hei 2 (1990)-45577A, and JP Hei 3 (1991)=287650A).

With these paints, basic compounds such as tertiary amine, quaternary ammonium salt and the like are normally used as curing catalyst. These basic compounds, however, exhibit high acceleration effect on reaction of carboxyl groups with epoxy groups and hence present a problem of insufficient storage stability of the paints.

As a paint aiming at improving storage stability, for example, JP Hei 7 (1995)-133340A disclosed a curable resin composition containing a latent curing catalyst formed of onium salt and acidic phosphoric acid ester, whose resin component comprises polyepoxide and carboxyl group- and/or cyclic acid anhydride group-containing curing agent. However, storage stability-improving effect for the paint is yet insufficient even when the latent curing catalyst is used. Furthermore, because onium salts are high-polarity compounds, they invite decrease in volume resistivity value of the paint and may cause troubles in electrostatic coatability.

### DISCLOSURE OF THE INVENTION

An object of the invention is to provide paint compositions of crosslinking type using combination of carboxyl group (acid anhydride group)/epoxy group, which excel in coating film performances including storage stability and curability, and electrostatic coatability.

We have engaged in concentrative studies with the view to solve the existing problems, and now discovered that the above object could be accomplished by using as a curing catalyst of paint compositions of crosslinking type using combination of carboxyl group (acid anhydride group)/epoxy group, a latent curing catalyst composed of tertiary amine and acidic phosphoric acid ester. This invention has thus come to completion.

Accordingly, therefore, the invention provides a paint composition characterized by comprising (A) carboxyl group- and/or cyclic acid anhydride group-containing compound, (B) polyepoxide and (C) a latent curing catalyst composed of (C-1) tertiary amine and (C-2) acidic phosphoric acid ester.

The invention also provides a multilayer coating film-forming method comprising successively applying onto a coating object at least one layer of colored base coat and at least one layer of clear coat, characterized by applying as the top clear coat the paint composition as described in the above.

In the paint composition of the present invention, the catalyst formed of tertiary amine and acidic phosphoric acid ester, which is used as the curing catalyst for the reaction of carboxyl groups and/or cyclic acid anhydride groups with epoxy groups, is assumed to act as a so-called thermal latent curing catalyst which newly develops catalytic function under heating, and the use of such curing catalyst can achieve the effect that the paint composition of the present invention excels in storage stability and curability.

### DETAILED DESCRIPTION OF THE INVENTION

Hereinafter the paint composition and the method for making multilayer coating film according to the present invention are explained in further details.

The paint composition of the invention comprises (A) carboxyl group- and/or cyclic acid anhydride group-containing compound, (B) polyepoxide and (C) a latent curing catalyst composed of (C-1) tertiary amine and (C-2) acidic phosphoric acid ester.

Carboxyl Group- and/or Cyclic Acid Anhydride Group-Containing Compound (A)

The compound (A) used in the present invention contains carboxyl group and/or cyclic acid anhydride group, which includes (A-1) polycarboxylic acid compound containing at least two carboxyl groups per molecule, (A-2) cyclic acid anhydride compound containing at least one cyclic acid anhydride group per molecule, and (A-3) carboxyl group-containing cyclic acid anhydride compound containing at least one each of carboxyl group and cyclic acid anhydride group per molecule.

Examples of the polycarboxylic acid compound (A-1) include low molecular weight compounds such as tetrahydrophthalic acid, hexahydrophthalic acid and trimellitic acid; and polycarboxylic acid resins of vinyl type, polyester type and the like.

Of those, examples of vinyl type polycarboxylic acid resin include (co)polymers formed by radical polymerization of carboxyl group-containing vinyl monomer and, where necessary, other vinyl monomer(s); (co)polymers formed by radical polymerization of acid anhydride group-containing vinyl monomer and, where necessary, other vinyl monomer(s), which are then half-esterified with alcohol (e.g., acetol, allyl alcohol, propargyl alcohol and methanol); (co)-polymers formed by radical polymerization of half-ester group-containing vinyl monomer and, where necessary, other vinyl monomer(s); and hydroxyl group-containing (co)polymers formed by radical (co)polymerization of hydroxyl group-containing vinyl monomer and, where necessary, other vinyl monomer(s), which are further half-esterified with acid anhydride compound (e.g., succinic anhydride).

Half-esterification as herein referred to is a reaction to add monohydric alcohol to acid anhydride group to induce the latter's ring opening to produce a group composed of carboxyl group and carboxylic acid ester group. Hereafter the group produced of the half-esterification may be simply referred to as half-ester group.

Example of carboxyl group-containing vinyl monomer useful for the preparation of vinyl type polycarboxylic acid resin include acrylic acid, methacrylic acid and adducts of hydroxyl group-containing vinyl monomer with Himic acid® anhydride; and examples of acid anhydride group-containing vinyl monomer include itaconic anhydride, maleic anhydride and the like.

As half-ester group-containing vinyl monomer, for example, compound obtained upon half-esterifying acid anhydride group of acid anhydride group-containing vinyl monomer and compound obtained by adding acid anhydride to hydroxyl group-containing vinyl monomer by half-esterification can be named

As specific examples of the compound obtained by half-esterification of acid anhydride group of acid anhydride group-containing vinyl monomer include esterification product of acid anhydride group-containing vinyl monomer such as maleic anhydride, itaconic anhydride or the like, with alcohol (e.g., acetol, allyl alcohol, propargyl alcohol or methanol).

As specific examples of the compound obtained by adding acid anhydride to hydroxyl group-containing vinyl monomer by half-esterification include those compounds obtained by adding such acid anhydride as phthalic anhydride, hexahydrophthalic anhydride and the like to hydroxyl group-containing vinyl monomers as exemplified in the following, by half-esterification.

Half-esterification can be effected either before or after the copolymerization reaction. As monohydric alcohols useful for the half-esterification, low molecular weight monohydric alcohols, for example, methanol, ethanol, isopropanol, tert-butanol, isobutanol, ethylene glycol monomethyl ether and ethylene glycol monoethyl ether can be named. The half-esterification reaction can be carried out following per se accepted method, for example, at temperatures ranging from room temperature to around 80° C., where necessary, using tertiary amine as catalyst.

As other vinyl monomer(s) useful in the preparation of vinyl type polycarboxylic acid resin, for example, hydroxyl group-containing vinyl monomer; (meth)acrylic acid esters; vinyl ethers and allyl ethers; olefin compounds and diene compounds; hydrocarbon ring-containing vinyl monomers; and nitrogen-containing vinyl monomers can be named. Examples of the hydroxyl group-containing vinyl monomer include C₂₋₈ hydroxyalkyl esters of (meth)acrylic acid such as 2-hydroxyethyl(meth)acrylate, 2-hydroxypropyl(meth)acrylate, 3-hydroxypropyl(meth)acrylate, 4-hydroxybutyl(meth)acrylate and the like; monoesters of polyether polyols such as polyethylene glycol, polypropylene glycol, polybutylene glycol and the like with unsaturated carboxylic acids such as (meth)acrylic acid; monoethers of polyether polyols such as polyethylene glycol, polypropylene glycol, polybutylene glycol and the like with hydroxyl group-containing unsaturated monomers such as 2-hydroxyethyl(meth)acrylate; diesterified products of acid anhydride group-containing unsaturated compounds such as maleic anhydride and itaconic anhydride, with glycols such as ethylene glycol, 1,6-hexanediol and neopentyl glycol; hydroxyalkylvinyl ethers such as hydroxyethylvinyl ether; unsaturated alcohol such as allyl alcohol; adducts of α,β-unsaturated carboxylic acid with monoepoxy compound such as Cardura E10 (tradename, Shell Sekiyu K.K.) and α-olefin-epoxide; adducts of glycidyl(meth)acrylate with monobasic acid such as acetic acid, propionic acid, p-tert-butylbenzoic acid and fatty acid; and adducts of above-named hydroxyl group-containing monomer with lactones (e.g., ε-caproloctone, γ-valerolactone and the like).

The term “(meth)acrylate” as used in this specification means acrylate or methacrylate; and “(meth)acrylic acid” means acrylic acid or methacrylic acid.

Specific examples of (meth)acrylic acid ester include C₁₋₂₄ alkyl esters or cycloalkyl esters of (meth)acrylic acid such as methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, hexyl(meth)acrylate, 2-ethylhexyl(meth)-acrylate, octyl(meth)acrylate, decyl(meth)acrylate, stearyl(meth)acrylate, lauryl(meth)acrylate and cyclohexyl(meth)acrylate; C₂₋₁₈ alkoxyalkyl esters of (meth)acrylic acid such as methoxybutyl(meth)acrylate, methoxyethyl(meth)acrylate and ethoxybutyl(meth)acrylate; and aromatic ring-containing (meth)acrylates such as phenyl(meth)acrylate, phenylethyl(meth)acrylate, phenylpropyl(meth)acrylate, benzyl(meth)acrylate and phenoxyethyl(meth)acrylate.

Examples of vinyl ether and allyl ether include chain alkyl vinyl ethers such as ethyl vinyl ether, n-propyl vinyl ether, isopropyl vinyl ether, butyl vinyl ether, tert-butyl vinyl ether, pentyl vinyl ether, hexyl vinyl ether and octyl vinyl ether; cycloalkyl vinyl ethers such as cyclopentyl vinyl ether and cyclohexyl vinyl ether; aryl vinyl ethers such as phenyl vinyl ether and tolyl vinyl ether; aralkyl vinyl ethers such as benzyl vinyl ether and phenethyl vinyl ether; and allyl ethers such as allyl glycidyl ether and allyl ethyl ether.

Examples of olefin compound and diene compound include ethylene, propylene, butylene, vinyl chloride, butadiene, isoprene and chloroprene.

Examples of hydrocarbon ring-containing vinyl monomer include styrene, α-methylstyrene and vinyltoluene.

Examples of nitrogen-containing vinyl monomer include nitrogen-containing alkyl(meth)acrylate such as N,N-dimethylaminoethyl(meth)acrylate N,N-diethylaminoethyl(meth)acrylate and N-tert-butylaminoethyl(meth)acrylate; polymerizable amides such as acrylamide, methacrylamide, N-methyl(meth)actylamide, N-ethyl(meth)acrylamide, N,N-dimethyl(meth)acrylamide, N,N-dimethylaminopropyl(meth)acrylamide and N,N-dimethylaminoethyl(meth)acrylamide; aromatic nitrogen-containing monomers such as 2-vinylpyridine, 1-vinyl-2-pyrrolidone and 4-vinylpyridine; polymerizable nitriles such as acrylonitrile and methacrylonitrile; and allylamine.

The (co)polymerization of these carboxyl group-containing vinyl monomers can be carried out by vinyl monomer polymerization methods in general, while solution type radical polymerization method in organic solvent is the most suitable in consideration of wider use and cost. Specifically, the copolymerization reaction can be effected, for example, in a solvent such as aromatic solvent, e.g., xylene, toluene; ketone solvent, e.g., methyl ethyl ketone, methyl isobutyl ketone; ester solvent, e.g., ethyl acetate, butyl acetate, isobutyl acetate, 3-methoxybutyl acetate; or alcoholic solvent, e.g., n-butanol, isopropyl alcohol; in the presence of a polymerization initiator such as azobisisobutyronitrile, benzoyl peroxide or the like, at temperatures ranging around 60-150° C. whereby an object vinyl type polycarboxylic acid resin can be easily obtained.

Where a half-ester group-containing vinyl monomer or acid anhydride group-containing vinyl monomer is used in the preparation of vinyl type polycarboxylic acid resin, it is generally adequate to use the half-ester group-containing vinyl monomer or acid anhydride group-containing vinyl monomer and other vinyl monomer(s) at the following ratios based on the combined amount of all the monomers: the half-ester group-containing vinyl monomer or acid anhydride group-containing vinyl monomer, within a range of 5-40 mass %, in particular, 10-30 mass %, from the viewpoints of curability and storage stability; and other vinyl monomer(s), 60-95 mass %, in particular, 70-90 mass %. When an acid anhydride group-containing vinyl monomer is used, half-esterification reaction can be carried out after the copolymerization reaction.

The vinyl type polycarboxylic acid resin preferably has a number-average molecular weight within a range of 1,000-10,000 in general, in particular, 2,000-8,000. When number-average molecular weight of the vinyl type polycarboxylic acid resin is less than 1,000, acid resistance of coating film may be reduced. Whereas, when it exceeds 10,000, the coating film may have degraded finished appearance due to decrease in compatibility with polyepoxide (B).

In the present specification, number-average molecular weight is a value calculated from a chromatogram measured with gel permeation chromatograph, based on the molecular weight of standard polystyrene. It can be measured using as the gel permeation chromatograph HLC8120GPC (tradename, Tosoh Corporation) and four columns of TSKgel G-4000HXL, TSKgel G-3000HXL, TSKgel G-2500-HXL and TSKgel G-2000HXL (tradenames, Tosoh Corporation), under the conditions of mobile phase; tetrahydrofuran, measuring temperature; 40° C., flow rate; 1 cc/min. and detecter; RI.

Preferably the vinyl type polycarboxylic acid resin has an acid value within a range of generally 50-500 mgKOH/g, in particular, 80-300 mgKOH/g. When acid value of the vinyl type polycarboxylic acid resin is less than 50 mgKOH/g, the resulting paint composition may have lowered curability leading to less acid resistance of the coating film, and when the acid value is more than 500 mgKOH/g, the resin's compatibility with polyepoxide (B) may decrease to impair finished appearance of the coating film.

Polyester type polycarboxylic acid resin named in the above include esters of polybasic acids with polyhydric alcohols. Examples of the polybasic acid include at least divalent polybasic acids such as phthalic acid (anhydride), isophthalic acid, terephthalic acid, succinic acid (anhydride), adipic acid, fumaric acid, maleic acid (anhydride), tetrahydrophthalic acid (anhydride), hexahydrophthalic acid (anhydride), trimellitic acid (anhydride), methylcyclohexene-tricarboxylic acid and pyromellitic acid (anhydride). Examples of polyhydric alcohols include ethylene glycol, propylene glycol, butylene glycol, diethylene glycol, butanediol, neopentyl glycol, cyclohexane-dimethanol, 1,6-hexanediol, 2-butyl-2-ethyl-1,3-propanediol, 3-methyl-1,5-pentanediol, glycerine, trimethylolethane, trimethylolpropane, pentaerythritol, bis(hydroxyethyl)terephthalate, (hydrogenated)bisphenol, polyisocyanate polyol and triethanolamine.

Such polyester type polycarboxylic acid resin is obtainable, for example, through single stage reaction under excessive presence of carboxyl groups of polybasic acid. Conversely, it can also be obtained by first synthesizing hydroxyl group-terminated polyester polymer under excessive presence of hydroxyl groups of polyhydric alcohol, and then adding thereto acid anhydride group-containing compound such as phthalic anhydride, hexahydrophthalic anhydride, succinic anhydride and the like.

The polyester type polycarboxylic acid resin preferably has a number-average molecular weight generally ranging from 500-10,000, in particular, 800-5,000, from the viewpoint of finished appearance of the coating film.

It is also preferred for the polyester type polycarboxylic acid resin to have an acid value generally within a range of 50-500 mgKOH/g, in particular, 80-300 mgKOH/g. Where the acid value of the polyester type polycarboxylic acid resin is less than 50 mgKOH/g, the resulting paint composition shows lowered curability which may reduce acid resistance of the coating film, and where the acid value is more than 500 mgKOH/g, the resin's compatibility with polyepoxide (B) may decrease to impair finished appearance of the coating film.

Hydroxyl group may be introduced into the polyester type polycarboxylic acid resin within a range as will make the hydroxyl value of the resin not higher than 100 mgKOH/g, preferably not higher than 80 mgKOH/g, for improving the resin's compatibility with polyepoxide (B) and adherability. Introduction of hydroxyl group can be effected by, for example, suspending the condensation reaction halfway, under the aforesaid condition of carboxyl group's excess. Under the condition of hydroxyl group's excess, the introduction can be easily effected by suspending the condensation reaction halfway, or by first synthesizing hydroxyl-terminated polyester polymer and thereafter reacting therewith an acid anhydride group-containing compound to be post-added, in an amount such that the acid groups should become less than the hydroxyl groups.

As the polyester type polycarboxylic acid resin, the particularly preferred are those obtained by subjecting polyhydric alcohol, for example, ethylene glycol, butylene glycol 1,6-hexanediol, trimethylolpropane or pentaerythritol, to an esterification reaction (which may be either of condensation reaction or ester-interchange reaction) with polyvalent carboxylic acid, for example, adipic acid, sebacic acid, terephthalic acid, isophthalic acid, phthalic anhydride, hexahydrophthalic anhydride and trimellitic anhydride, or lower alkylation products of these polyvalent carboxylic acids, under a condition rendering the amount of the hydroxyl groups in excess of the amount of the carboxyl groups (a mol of acid anhydride group being calculated as 2 mols of carboxyl group); and subjecting the resulting polyester polyol to half-esterification reaction with acid anhydride compound such as, for example, phthalic anhydride, hexahydrophthalic anhydride, succinic anhydride and trimellitic anhydride.

The polyester polyol in the above is obtainable under normal esterification reaction conditions. Preferably the resulting polyester polyol has a number-average molecular weight within a range of generally 350-4700, in particular, 400-3000; and a hydroxyl value within a range of generally 70-400 mgKOH/g, in particular, 150-350 mgKOH/g.

The half-esterification reaction of the polyester polyol for obtaining the polyester type polycarboxylic acid resin can be carried out, following accepted practice, for example, at temperatures around room temperature to about 80° C. Thus obtained polyester type polycarboxylic acid resin preferably has a number-average molecular weight within a range of generally 800-5000, in particular, 900-3000; and an acid value within a range of generally 50-500 mgKOH/g, in particular, 100-400 mgKOH/g.

Examples of the cyclic acid anhydride compound (A-2) include (co)polymers formed by radical polymerization of 1,2-carboxylic anhydride such as maleic anhydride, succinic anhydride, dodecylsuccinic anhydride, tetrahydrophthalic anhydride, 3-methyltetrahydrophthalic anhydride, hexahydrophthalic anhydride, 3-methylhexahydrophthalic anhydride, Himic acid® anhydride, Het acid anhydride, phthalic anhydride and the like with aforesaid acid anhydride group-containing vinyl monomer, and optionally other vinyl monomer as above described.

Also examples of carboxyl group-containing cyclic acid anhydride compound (A-3) include copolymers formed by radical polymerization of polybasic acid anhydride such as trimellitic anhydride, aforesaid carboxyl group-containing vinyl monomer, acid anhydride group-containing vinyl monomer and, where necessary, still other vinyl monomer.

As the carboxyl group- and/or acid anhydride group-containing compound, polycarboxylic acid compound (A-1), in particular, polycarboxylic acid resin such as vinyl type polycarboxylic acid resin and polyester type polycarboxylic acid resin are preferred, among those described in the foregoing.

### Polyepoxide (B)

Polyepoxide (B) used in this invention is a resin having at least about two epoxy groups, on an average, per molecule. As the polyepoxide (B), those already known can be used, while acrylic resins having, on an average, about 2-50 epoxy groups per molecule are preferred, from the viewpoint of obtaining cured coating film of excellent performances of finished appearance, weatherability, acid resistance and the like.

Such acrylic resins can be synthesized, for example, by copolymerization of epoxy group-containing vinyl monomers and other vinyl monomers, by the method similar to those described in respect of the above compound (A).

Examples of the epoxy group-containing vinyl monomer include glycidyl(meth)acrylate, allyl glycidyl ether and 3,4-epoxycyclohexylmethyl(meth)acrylate, and as other vinyl monomer, those earlier named as examples in respect of the compound (A) can be used.

The polyepoxide (B) may also contain hydroxyl groups within a range to make its hydroxyl value not higher than 100 mgKOH/g, in particular, 20-80 mgKOH/g, for improving its compatibility with the compound (A) and adherability of the coating film of the paint composition containing the same. Introduction of hydroxyl groups into the polyepoxide can be effected, for example, by using, as a part of the other vinyl monomer component, a hydroxyl group-containing vinyl monomer in the copolymerization.

As hydroxyl group-containing vinyl monomer, those exemplified in respect of the compound (A) can be used.

The copolymerization ratio of an epoxy group-containing vinyl monomer preferably lies within a range of normally 5-60 mass %, in particular, 10-45 mass %, inter alia, 20-40 mass %, based on the combined amount of all the monomers used, from the viewpoint of curability and storage stability of resulting paint composition. The copolymerization ratio of other vinyl monomer preferably lies normally within a range of 40-95 mass %, in particular, 55-90 mass %, inter alia, 60-80 mass %.

The polyepoxide (B) preferably has an epoxy group content within a range of normally 0.5-5.0 millimols/g, in particular, 0.8-3.5 millimols/g, inter alia, 1.0-3.0 millimols/g. When the epoxy group content of polyepoxide (B) is less than 0.5 millimol/g, curability of the resulting paint composition drops and may invite degradation in the coating film performance such as acid resistance. Whereas, when the epoxy group content becomes more than 5.0 millimols/g, compatibility of the polyepoxide (B) with the compound (A) may decrease.

The polyoxide (B) furthermore preferably has a number-average molelcular weight within a range of generally 1,000-20,000, in particular, 1,200-10,000, inter alia, 1,500-8,000. Where the number-average molecular weight of the polyepoxide (B) is less than 1,000, acid resistance of cured coating film deteriorates in occasions. Conversely, when it exceeds 20,000, surface smoothness of resulting coating film deteriorates in occasions.

### Latent Curing Catalyst (C)

The latent curing catalyst (C) to be used in the present invention is composed of tertiary amine (C-1) and acidic phosphoric acid ester (C-2). The two may be in the form of a mixture or a reaction product.

The tertiary amine (C-1) is a compound represented by a general formula R₁R₂R₃N, wherein R₁, R₂ and R₃ may be the same or different and each stands for a hydrocarbon group, the hydrogen atom(s) in the hydrocarbon group(s) being optionally substituted with halogen or hydroxyl group(s). Examples of the hydrocarbon group include linear or branched C₁₋₂₀ alkyl, C₃₋₁₀ cycloalkyl, aryl such as phenyl and tolyl, and aralkyl such as benzyl and phenethyl. Thus, specific examples of the tertiary amine (C-1) include trialkylamines such as trimethylamine, triethylamine, triisopropylamine, tri-n-propylamine, tri-n-butylamine, N,N-dimethylhexylamine, N,N-dimethyloctylamine, N,N-dimethyldecylamine, N,N-dimethyllaurylamine, N,N-dimethylmyristylamine, N,N-dimethylpalmitylamine, N, N-dimethylstearylamine, N,N-dimethylbehenylamine, N,N-dimethylcocoalkylamine, N,N-dimethyloleylamine, N-methyldihexylamine, N-methyldioctylamine, N-methyldidecylamine, N-methyldicocoalkylamine, and N-methyldioleylamine; trialkanolamines such as trimethanolamine and triethanolamine; N,N-dialkylalkanolamines such as N,N-dimethylethanolamine and N,N-diethylethanolamine; N-alkyldialkanolamines such as N-methyldiethanolamine and N-ethyldiethanolamine; and N-alkylmorpholines such as N-methylmorpholine and N-ethylmorpholine. These can be used either singly or in combination of two or more.

Of these, those tertiary amine compounds of the above general formula in which at least one of R₁, R₂ and R₃ is a hydrocarbon group containing at least 8, in particular, at least 12, inter alia, at least 16, carbon atoms are preferred, for preventing deterioration in electrostatic coatability, which is caused by drop in electric resistance, of the coating composition. Among such preferred compounds, particularly methyldialkylamines and dimethylalkylamines whose alkyl moiety contains at least 8 carbon atoms are preferred, the former methyldialkyl tertiary amines being the most preferred.

As such methyldialkyl tertiary amines, for example, N-methyldioctylamine, N-methyldidecylamine, N-methyldilaurylamine, N-methyldimyristylamine, N-methyldipalmitylamine, N-methyldistearylamine, N-methyldioleylamine, N-methyldibehenylamine, N-methyldicocoalkylamine, and N-methyl-hardened beef tallow alkylamine can be named. Of these methyldialkyl tertiary amines, N-methyldicocoalkylamine and N-methyl-hardened beef tallow alkylamine can be conveniently used.

As dimethylalkyl tertrary amines, for example, N,N-dimethyloctylamine, N,N-dimethyldecylamine, N,N-dimethyllaurylamine, N,N-dimethylmyristylamine, N,N-dimethylpalmitylamine, N,N-dimethylstearylamine, N,N-dimethyloleylamine, N,N-dimethylbehenylamine, N,N-dimethylcocoalkylamine and N,N-dimethyl-hardened beef tallow alkylamine can be named. Of these dimethylalkyl tertiary amines, N,N-dimethylcocoalkylamine and N,N-dimethyl-hardened beef tallow alkylamine are the preferred.

The acidic phosphoric acid ester (C-2) includes organic acidic phosphoric or phosphorous acid esters formed by substituting a part of hydrogen atoms in inorganic phosphorus compound such as phosphoric acid, phosphorous acid or condensates thereof, with hydrocarbon group such as alkyl or aryl group. The alkyl may be either linear or branched, examples of which including C₁₋₁₂ alkyl groups such as methyl, ethyl, n-propyl, iso-propyl, n-butyl, iso-butyl, sec-butyl, tert-butyl, n-pentyl, n-hexyl, n-heptyl, 2-ethylhexyl and n-decyl. Examples of the aryl include phenyl and naphthyl.

Thus, as specific examples of the acidic phosphoric acid ester (C-2), dimethyl phosphate, diethyl phosphate, dipropyl phosphate, monobutyl phosphate, dibutyl phosphate, mono-2-ethylhexyl phosphate, di-2-ethylhexyl phosphate, bis(ethylhexyl)phosphate, monophenyl phosphate, diphenyl phosphate and mono-2-ethylhexyl phosphite can be named. Of these, dibutyl phosphate, bis(ethylhexyl)phosphate and diphenyl phosphate, in particular, diphenyl phosphate, are preferred, from the viewpoint of storage stability of the paint composition.

The use ratio between the tertiary amine (C-1) to the acidic phosphoric acid ester (C-2) is, based on the combined amount of these two components, the tertiary amine (C-1) can be within a range of generally 2-90 mass %, preferably 25-75 mass %, inter alia, 35-65 mass %; and the acidic phosphoric acid ester (C-2), within a range of generally 10-98 mass %, preferably 25-75 mass %, inter alia, 35-65 mass %. When the use ratio of the tertiary amine (C-1) is less than 2 mass % and that of the acidic phosphoric acid ester (C-2), more than 98 mass %, low temperature curability of the paint composition may drop. On the other hand, when the use ratio of the tertiary amine (C-1) is more than 90 mass % and that of the acidic phosphoric acid ester (C-2) is less than 10 mass %, storage stability of the paint composition may be impaired.

As preferred combination of tertiary amine (C-1) and acidic phosphoric acid ester (C-2) in the latent curing catalyst (C), those between methyldialkylamine or dimethylalkylamine whose alkyl moiety has 8-24 carbon atoms and diphenyl phosphate can be named.

The latent curing catalyst (C) used in the paint composition of the present invention excels over that composed of an onium salt such as quaternary ammonium salt and phosphoric acid ester compound, in that it can improve storage stability of the paint and prevent reduction in electrostatic coatability in consequence of drop in volume resistivity value of the paint, without impairing curability of the paint.

### Paint Composition

The blend ratio of the compound (A) to polyepoxide (B) in the paint composition of the present invention preferably lies within a range of, in terms of the equivalent ratio of the former's carboxyl groups to the latter's epoxide groups, generally 1:0.5-1:2, in particular, 1:0.75-1:1.75, inter alia, 1:1-1:1.5.

The blend ratio of the latent curing catalyst (C) per 100 mass parts of the sum of the compound (A) and polyepoxide (B) preferably lies within a range of generally 0.1-10 mass parts, in particular, 0.5-7.5 mass parts, inter alia, 1-5 mass parts. When the blend ratio of the latent curing catalyst (C) is less than 0.1 mass part per 100 mass parts of the sum of the compound (A) and polyepoxide (B), sufficient curability of the coating film may not be obtained due to the small blend ratio. On the other hand, when it exceeds 10 mass parts, low temperature curability-improving effect may decrease, or the storage stability may deteriorate.

The paint compositions according to the invention may contain, where necessary, so-called dehydrator such as trimethyl orthoacetate, for suppressing degradation of the paint caused by moisture present in the paint or in the air.

The paint compositions of the present invention may also be blended with per se known pigments in general, such as coloring pigment, extender, effect pigment and rust preventive pigment. As the pigments, for example coloring pigments such as titanium dioxide, zinc flower, Carbon Black, Cadmium Red, Molybdate Red, chrome yellow, chromium oxide, Prussian blue, Cobalt Blue, azo pigment, phthalocyanine pigment, quinacridone pigment, isoindoline pigment, vat pigment and perylene pigment; extenders such as talc, clay, kaoline, baryta, barium sulfate, barium carbonate, calcium carbonate, silica and alumina white; and effect pigments such as aluminum powder, mica powder and titanium dioxide-coated mica powder can be named.

The paint compositions of the present invention can further contain, where necessary, resin(s) other than the compound (A) and polyepoxide (B), for example, acrylic resin, polyester resin, alkyd resin, silicone resin and fluorinated resin. In certain occasions, they may also concurrently contain a minor amount of a crosslinking agent such as melamine resin or blocked polyisocyanate compound. The paint compositions of the invention can further contain, where necessary, paint additives in general, such as UV absorber, light stabilizer, antioxidant, surface regulating agent or defoamer.

As the UV absorber, those known per se can be used, e.g., benzotriazole-type absorber, triazine-type absorober, salicylic acid derivative-type absorber or benzophenone-type absorber. Preferred content of such a UV absorber in the paint composition in respect of weatherability and yellowing resistance is, per 100 mass parts of the total solid resin content, within a range of normally 0-10 mass parts, in particular, 0.2-5 mass parts, inter alia, 0.3-2 mass parts.

As the light stabilizer, those known per se can be used, as examples of which hindered amine type light stabilizers can be named. Preferred content of such a light stabilizer in the paint composition in respect of weatherability and yellowing resistance is, per 100 mass parts of the total solid resin content, within a range of normally 0-10 mass parts, in particular, 0.2-5 mass parts, inter alia, 0.3-2 mass parts.

The form of the paint composition of the present invention is not particularly limited, but organic solvent-based type is normally preferred. As the organic solvent useful for organic solvent-based type paint compositions, various organic solvents for paint, e.g., aromatic or aliphatic hydrocarbon solvents; alcoholic solvents; ester solvents; ketone solvents; and ether solvents can be named. The solvent which was used at the preparation time of the polymer to be blended may be used in situ, or a solvent may be suitably added at the time of paint preparation. The solid concentration in the paint composition may be within a range of usually about 30-about 70 mass %, preferably about 40-about 60 mass %.

### Coating Method of the Paint Compositions

Coating objects to which the paint compositions of the invention are applicable are not particularly limited, while, for example, sheet steel such as cold rolled sheet steel, zinc-plated sheet steel, zinc alloy-plated sheet steel, stainless steel sheet and tin-plated sheet steel; light metal substrates such as aluminum plate and aluminum alloy plate; and various plastic materials are preferred. They may also be bodies of various vehicles such as automobiles, two-wheeled vehicles and container cars formed thereof.

The coating objects may also be metallic surfaces of sheet steel, light metal substrates or of car bodies, which have been given a surface treatment such as phosphate treatment, chromate treatment or complex oxide treatment.

The coating objects may also be those car bodies, sheet steel, light metallic substate and the like on which undercoat such as of various electrodeposition paints and/or intermediate coat have been formed.

The coating objects may furthermore be the surfaces on which coating film has been formed by successive application of intermediate paint and coloring paint. The coating film formed by application of coloring paint or the like may be either cured or uncured, but from the viewpoint of cutting down heat-curing steps, a preferred practice is to apply a paint composition of the present invention on an uncured coating film and heat-curing the coating film formed therefrom concurrently with that of the coloring paint.

Specific examples of such coloring paint include solid color paint, metallic paint, iridescent paint and the like. In particular, liquid thermosetting paint comprising a resin component, pigment and, where necessary, organic solvent or water which is a volatile component.

Specific examples of the resin component include those composed of at least one base resin selected from acrylic resin, vinyl resin, polyester resin, alkyd resin, urethane resin and the like which have crosslinkable functional groups (e.g., hydroxyl, epoxy, carboxyl or alkoxysilyl groups), and a crosslinking agent to crosslink and cure those resins, for example, at least one selected from known crosslinking agents for use in paint, e.g., alkyletherified melamine resin, urea resin, guanamine resin, optionally blocked polyisocyanate compound, epoxy compound, and carboxyl group-containing compound. It is preferred to use the base resin and the crosslinking agent at such a ratio, based on their combined mass, within a range of generally 50-90 mass %, in particular, 60-80 mass % of the base resin; and generally 50-10 mass %, in particular, 40-20 mass %, of the crosslinking agent.

The pigment includes coloring pigment, metallic pigment and iridescent pigment. Examples of coloring pigment include inorganic pigments such as titanium dioxide, zinc flower, Carbon Black, Cadmium Red, Molybdate Red, chrome yellow, chromium oxide, Prussian blue and Cobalt Blue; and organic pigments such as azo pigment, phthalocyanine pigment, quinacridone pigment, isoindoline pigment, vat pigment and perylene pigment. As the typical example of the metallic pigment, aluminum flakes can be named, and also special metal vapor-deposited film flakes or glass flakes can be used. As photo-iridescent pigment, for example, mica, metal oxide-coated mica, micaceous iron oxide and hologram pigment can be named. These pigments can be used either singly or in combination of two or more.

It is also possible to use a paint composition of the present invention as the coloring paint.

Coating of such coloring pigment on either directly on metallic and/or plastic coating object such as outer panels of automobiles, or on undercoat applied thereon such as of cationic electrocoating paint or the like and cured, or on an intermediate coat further applied thereon and cured, can be carried out by adjusting viscosity of such coloring pigment to 15-60 seconds with Ford cup viscosimeter No. 4 at 20° C. and applying it by such coating method as airless spray, air spray, rotary atomizing coating or the like. In the occasion of the coating, static electricity may be applied, where necessary. The coating film thickness of the coloring pigment can be within a range of, as that of cured film, normally 5-50 μm, preferably 10-30 μm.

The coating object may also be one on which cured or uncured coating film of ordinary clear paint is formed.

Curing of the coating film can be effected, while differing depending on the base resin component used, by heating the film normally at about 80-about 180° C., preferably at about 100-about 160° C., for about 10-40 minutes.

Preceding the curing by heating, or preceding the application of a paint composition of the present invention onto the uncured coating film, a preheating at temperatures of, e.g. about 50-about 80° C. for about 3-10 minutes may be given to promote volatilization of volatile component, where necessary.

Coating method of the paint composition of the present invention is subject to no particular limitation and such method as air spray coating, airless spray coating, rotary atomizing coating or curtain coating can be used. If necessary, static electricity may be applied in carrying out these coating methods. Of these methods, air spray coating is particularly preferred. Preferred application rate of the paint composition of the present invention is normally such that will make the cured coating film thickness within a range of about 10-about 50 μm.

In the occasions of the air spray coating, airless spray coating or rotary atomizing coating, it is preferred to adjust the viscosity of the paint composition of the present invention to a range suitable for such coating methods, more specifically to a viscosity range of, for example, normally about 15-60 seconds at 20° C. as measured with Ford cup No. 4 viscosimeter, with a solvent such as an organic solvent.

Curing of wet coating film of the paint composition of the present invention as formed on a coating object is conducted by heating. The heating can be effected by per se known heating means, for example, by using a drying oven such as hot air oven, electric oven, infrared induction heating oven and the like. Suitable heating temperature is normally within a range of 100-180° C., preferably 120-160° C. The heating time is not particularly limited, while it is normally preferred to finish it within a range of 5-60 minutes.

The paint compositions of the present invention excel in low temperature curability particularly when they are in one-package type, and are capable of forming coating film excellent in finished appearance and acid resistance, and hence are conveniently used as top clear coat paint, in particular, as top coat paint for automobiles. As top coat paint for automobiles, they can be used as solid color paint and clear coat paint for metallic colors such as in 2-coat-1-bake, 2-coat-2-bake, 3-coat-1-bake and 3-coat-2-bake systems.

### Multilayer Coating Film-Forming Method

The invention provides a method of forming multilayer coating film, using as a paint composition according to the present invention as a top clear coat paint, which comprises successively applying onto a coating object at least one layer of coloring base coat paint and at least one layer of clear coat paint to form a multilayer coating film, characterized by applying a paint composition of the invention as the uppermost layer clear coat paint.

As a specific example of the method, a multilayer coating film-forming method by 2-coat-1-bake system can be practiced, which comprises applying onto a coating object on which an electrodeposited coat and optionally further an intermediate coat have been applied, a solvent-based or water-based base coat paint; optionally pre-heating the uncured coating film for promoting volatilization of the solvent in the base coat paint, for example, at about 40-about 90° C. for around 3-30 minutes; thereafter applying onto the uncured base coat film a paint composition of the present invention as a clear coating paint; and curing the base coat and the clear coat at the same time.

The paint composition of the present invention can also be conveniently used as the top clear coat in 3-coat-2-bake system or 3-coat-1-bake system multilayer coating film-forming method, which comprises successively applying onto a coating object on which an electrodeposited coat and optionally further an intermediate coat have been applied, a first base coat, a second base coat and the clear coat, by the order stated.

As the base coating paint in the above methods, heretofore known thermosetting base coating paint in general can be used. More specifically, for example, paints comprising a base resin such as acrylic resin, polyester resin, alkyd resin or urethane resin in suitable combination with a curing agent such as amino resin, polyisocyanate compound or blocked polyisocyanate compound can be used. As the base coating paint, high solid paint, water-based paint or powder paint are preferred, in consideration of environmental problems and source saving.

In the above multilayer coating film-forming methods, two or more clear coats may be applied. In such occasions, known thermosetting clear paint other than the paint composition of the present invention can be used, as the first clear coat.

### EXAMPLES

Hereinafter the present inventions are more specifically explained, referring to working Examples and Comparative Examples, it being understood that the inventions are not limited to the following Examples. Hereafter “part” and “%” are invariably based on mass, and thickness of coating film invariably refers to cured coating film thickness.

### Production Examples of Carboxyl Group-Containing Compound (A)

### Production Example 1

A 4-necked flask equipped with a stirrer, thermometer, condenser tube and nitrogen gas inlet was charged with 680 parts of SWAZOL 1000 (tradename, COSMO OIL Co., Ltd, a hydrocarbon type organic solvent) whose temperature was elevated to 125° C. under passing of nitrogen gas. After it reached 125° C., the nitrogen gas supply was stopped, and into the flask a monomeric mixture composed of the following monomers, solvent and polymerization initiator was dropped uniformly over 4 hours. In the following, p-tert-butylperoxy-2-ethyl hexanoate is a polymerization initiator.

| | parts |
|---|---|
| Styrene | 500 |
| Cyclohexyl methacrylate | 500 |
| Isobutyl methacrylate | 500 |
| Maleic anhydride | 500 |
| 2-Ethoxyethyl propionate | 1000 |
| p-tert-Butylperoxy-2-ethyl hexanoate | 100 |

While passing nitrogen gas therethrough at 125° C., the content of the flask was aged for 30 minutes, followed by further dropwise addition of a mixture of 10 parts of p-tert-butylperoxy-2-ethyl hexanoate and 80 parts of SWAZOL 1000 over an hour. Thereafter the reaction mixture was cooled to 60° C., and to which 490 parts of methanol and 4 parts of triethylamine were added, followed by 4 hours' half-esterification reaction under reflux. Thereafter 326 parts of superfluous methanol was removed under reduced pressure, to provide a solution of carboxyl group-containing compound (a-1).

Thus obtained solution of the carboxyl group-containing compound (a-1) had a solid content of 55 mass % and number-average molecular weight of about 3500. Also the half acid value of this compound was 130 mgKOH/g.

### Production Example 2

A 4-necked flask equipped with a stirrer, thermometer, condenser tube and nitrogen gas inlet was charged with 650 parts of SWAZOL 1000 (tradename, COSMO OIL Co., Ltd, a hydrocarbon type organic solvent) whose temperature was elevated to 125° C. under passing of nitrogen gas. After it reached 125° C., the nitrogen gas supply was stopped, and into the flask a monomeric mixture composed of the following monomers, solvent and polymerization initiator was dropped uniformly over 4 hours.

| | parts |
|---|---|
| Methyl methacrylate | 40 |
| n-Butyl methacrylate | 1000 |
| n-Butyl acrylate | 600 |
| Styrene | 60 |
| Acrylic acid | 300 |
| 2-Ethoxyethyl propionate | 900 |
| p-tert-Butylperoxy-2-ethyl hexanoaote | 100 |

While passing nitrogen gas therethrough at 125° C., the content of the flask was aged for 30 minutes, followed by further dropwise addition of a mixture of 10 parts of p-tert-butylperoxy-2-ethyl hexanoate and 80 parts of SWAZOL 1000 over an hour. Aging the reaction mixture for additional 30 minutes, a solution of carboxyl group-containing compound (a-2) was obtained.

Thus obtained solution of the carboxyl group-containing compound (a-2) had a solid content of 55 mass % and number-average molecular weight of about 3400. Also the acid value of this compound was 117 mgKOH/g.

### Production Example 3

A 4-necked flask equipped with a stirrer, thermometer, condenser and nitrogen gas inlet was charged with 566 parts of 1,6-hexanediol, 437 parts of trimethylolpropane, 467 parts of adipic acid and 308 parts of hexahydrophthalic anhydride, whose temperature was raised to 180° C. in nitrogen atmosphere. Thereafter the temperature was raised to 230° C. consuming 3 hours, and at said temperature the monomeric mixture was allowed to react for an hour. Xylene was added and the reaction was continued under reflux. Upon confirming that the resin acid value decreased to not higher than 3 mgKOH/g, the reaction system was cooled to 100° C., followed by addition of 1294 parts of hexahydrophthalic anhydride. The temperature was raised again to 140° C., and the reaction was further continued for 2 hours. After cooling, the reaction mixture was diluted with xylene to provide a solution of carboxyl group-containing compound (a-3).

Thus obtained solution of the carboxyl group-containing compound (a-3) had a solid content of 65 mass % and number-average molecular weight of 1,040. Also the acid value of this compound was 160 mgKOH/g.

### Production Example of Polyepoxide (B)

### Production Example 4

A 4-necked flask equipped with a stirrer, thermometer, condenser tube and nitrogen gas inlet was charged with 410 parts of xylene and 77 parts of n-butanol, whose temperature was raised to 125° C. under passing of nitrogen gas. After it reached 125° C., the nitrogen gas supply was stopped, and into which a monomeric mixture composed of the following monomers and a polymerization initiator was dropped uniformly over 4 hours. In the following, azobisisobutyronitrile is a polymerization initiator.

| | parts | |
|---|---|---|
| Glycidyl methacrylate | 432 | (30%) |
| n-Butyl acrylate | 720 | (50%) |
| Styrene | 288 | (20%) |
| Azobisisobutyronitrile | 72 | |

While passing nitrogen gas therethrough at 125° C., the content of the flask was aged for 30 minutes, followed by further dropwise addition of a mixture of 90 parts of xylene, 40 parts of n-butanol and 14.4 parts of azobisisobutyronitrile over 2 hours. Further aging the reaction mixture for additional 2 hours, a solution of polyepoxide (b-1) was obtained.

Thus obtained solution of polyepoxide (b-1) had a solid content of 70 mass % and number-average molecular weight of 2000. The epoxy group content of the polyepoxide (b-1) was 2.12 millimols/g.

### Preparation of Paint Compositions

### Examples 1-8 and Comparative Examples 1-8

Those carboxyl group-containing compounds and polyepoxide as obtained in above Production Examples 1-4, and starting materials as given in later-appearing Table 1 were mixed with a rotor blade stirrer at the blend ratios as given in the Table 1 and converted to paints. Thus paint composition Nos. 1-16 were obtained. The blend ratios in the paint compositions as shown in Table 1 are by mass ratios of solid contents of individual components.

The notes (*1)-(*11) in the Table 1 mean the following:

(*1) ARMIN M2HT: tradename, Lion Akzo Co., N-methyl hardened beef tallow alkylamine (tertiary amine, chief components; component having C₁₈ alkyl group (64%), and one having C₁₂ alkyl group (30%)

(*2) ARMIN DMCD: tradename, Lion Akzo Co., N,N-dimethylcocoalkylamine (tertiary amine, chief components; component having C₁₂ alkyl group (61%), one having C₁₄ alkyl group (31%) and one having C₁₆ alkyl group (8%))

(*3) ARMIN M2C: tradename, Lion Akzo Co., N-methyldicoco-alkylamine (tertiary amine, chief components; component having C₁₂ alkyl group (60%), one having C₁₄ alkyl group (22%), one having C₁₆ alkyl group (8%), and one having C₁₀ alkyl group (7%))

(*4) ARMIN 2C: tradename, Lion Akzo Co., dicocoalkylamine (secondary amine, chief components; component having C₁₂ alkyl group (60%), one having C₁₄ alkyl group (22%), one having C₁₆ alkyl group (8%) and one having C₁₀ alkyl group (7%))

(*5) ARMIN CD: tradename, Lion Akzo Co., cocoalkylamine (primary amine, chief components; component having C₁₂ alkyl group (60%), one having C₁₄ alkyl group (22%), one having C₁₆ alkyl group (8%) and one having C₁₀ alkyl group (7%))

(*6) TBAB: tradename, Lion Akzo Co., tetrabutylammonium bromide

(*7) Phosphoric Acid A: bis(ethylhexyl)phosphate

(*8) Phosphoric Acid B: diphenyl phosphate

(*9) Phosphoric Acid C: dibutyl phosphate

(*10) DDBSA: dodecylbenzenesulfonic acid

(*11) BYK-300: tradename, BYK-Chemie GmbH, surface regurating agent

To each of the paint composition Nos. 1-16 as obtained in above Examples 1-8 and Comparative Example 1-8, SWAZOL 1000 (tradename, COSMO OIL Co., Ltd., hydrocarbon type solvent) was added and their viscosity was adjusted with Ford cup No. 4.

Thus obtained paint compositions were subjected to the following tests.

Storage stability: Each paint composition was diluted to have a viscosity of 35 seconds (20° C.), as measured with Ford cup No. 4, and stored airtightly at 60° C. for 16 hours. Thereafter its viscosity was measured once again with Ford cup No. 4 (20° C.).

Electric resistance: Using as the samples the paint composition which were diluted to have a viscosity of 25 seconds (20° C.) with Ford cup No. 4, and the samples' volume resistivity values were measured with Landsberg tester.

Xylene elution ratio (%): Each of the paint compositions was diluted to have a viscosity of 25 seconds (20° C.) with Ford cup No. 4, applied onto a tin plate to a film thickness of 40 μm, cured by heating at 140° C. for 30 minutes, and the coating film was peeled off to serve as the sample.

About 0.2 g of the sample coating film whose mass was measured in advance was immersed in xylene at 30° C. for 3 hours, withdrawn, dried at 110° C. for an hour, and its mass was measured. The sample's xylene elution ratio (%) was determined according to the following equation (1):

xylene elution ratio (%)=[(A−B)/A]×100 (1)

in which

A: mass of initial coating film,

B: mass of the coating film after three hours' immersion in xylene and the following an hour's drying at 110° C.

Test panels were prepared with the paint composition Nos. 1-16, which were subjected to the following tests.

### Preparation of Test Panel 1

A zinc phosphated, 0.8 mm-thick dull steel plate was electrocoated with a thermosetting epoxy resin type cationic electrocoating paint (ELECRON GT-10, tradename, Kansai Paint Co.) to a film thickness of 20 μm which was then cured by heating at 170° C. for 30 minutes. A polyester resin-melamine resin type intermediate paint for automobiles (AMILAC TP-65-2, tradename, Kansai Paint Co.) was air spray coated thereon to a film thickness of 35 μm and cured by heating at 140° C. for 30 minutes. Further onto the coating film a water-based metallic base coat (WBC713 #202, tradename, Kansai Paint Co., an acrylic-melamine resin type water-based base coat for automobiles, black in color) was applied to a film thickness of 15 μm and allowed to stand at room temperature for 5 minutes, followed by a pre-heating at 80° C. for 10 minutes. Onto the uncured coating film, each of the paint compositions as diluted to have a viscosity of 25 seconds (20° C.) with Ford cup No. 4 was applied to a film thickness of 35 μm, which was allowed to stand at room temperature for 10 minutes. Then the two coating films were concurrently cured by heating at 140° C. for 30 minutes, to provide the test panels.

Surface smoothness of the coating films on the test panels was evaluated by the following method.

Coated surface smoothness: Smoothness of the coated film surface was measured with Wave Scan (tradename, BYK Gardner Co.). The Wave Scan can measure Long Wave valve (LW) and Short Wave value (SW).

Long Wave value is an index of amplitude of surface roughness of the wavelength ranging 1.2-12 mm, and can evaluate large amplitude such as of, e.g., orange peel of coating film surface. Short Wave value is an index of amplitude of surface roughness of the wavelength ranging 0.3-1.2 mm, and can evaluate small amplitude of fine structure of coating film surface.

As to both of the Wave Scan values, less measured values indicate higher smoothness of the coating film surface.

Test panels were also prepared in the following manner and their yellowing resistance was evaluated.

### Preparation of Test Panel 2

Up to the formation of the intermediate coating film, the same procedures to those in the above preparation of test panel 1 were carried out. On the intermediate coating film, a white top coat for automobiles (Neo 6000, tradename, Kansai Paint Co., polyester resin-melamine resin type paint) was air spray coated to a film thickness of 40 μm, left at room temperature for 7 minutes and then heated at 140° C. for 20 minutes to be cured. The panel on which the top coating film was thus formed was used as the standard panel.

The standard panels were air spray coated with each of the paint compositions to a film thickness of 40 μm, left at room temperature for 7 minutes and then cured by heating at 140° C. for 20 minutes to form clear coating film, to provide test panels.

Yellowing resistance of the test panels was evaluated by Δb value based on CIE color-matching function of each test panel to the standard panel. Less Δb value indicates better yellowing resistance. The Δb value measurement was conducted with Color Guide 45/0 (tradename, BYK Gardener Co.).

The above test results are shown in Table 1, concurrently with compositions of the paint composition Nos. 1-16.

TABLE 1

| | | Example | | | | | | | | Comparative Example | | | | | | | |
|---|---|---|---|---|---|---|---|---|---|---|---|---|---|---|---|---|---|
| | | 1 | 2 | 3 | 4 | 5 | 6 | 7 | 8 | 1 | 2 | 3 | 4 | 5 | 6 | 7 | 8 |
| Paint Composition No. | | 1 | 2 | 3 | 4 | 5 | 6 | 7 | 8 | 9 | 10 | 11 | 12 | 13 | 14 | 15 | 16 |
| Carboxyl group-containing | | 50 | 45 | 50 | 50 | 50 | 50 | | | 50 | 50 | 50 | 50 | 50 | 50 | 50 | 50 |
| compound (a-1) | | | | | | | | | | | | | | | | | |
| Carboxyl group-containing | | | | | | | | 50 | | | | | | | | | |
| compound (a-2) | | | | | | | | | | | | | | | | | |
| Carboxyl group-containing | | | 10 | | | | | | 35 | | | | | | | | |
| compound (a-3) | | | | | | | | | | | | | | | | | |
| Polyepoxide (b-1) | | 50 | 45 | 50 | 50 | 50 | 50 | 50 | 65 | 50 | 50 | 50 | 50 | 50 | 50 | 50 | 50 |
| ARMIN M2HT (*1) | | 1.5 | 1.5 | | | 1.5 | 1.5 | 1.5 | 1.5 | 1.5 | | | | | 1.5 | 1.5 | |
| ARMIN DMCD (*2) | | | | 0.6 | | | | | | | | | | | | | |
| ARMIN M2C (*3) | | | | | 1.0 | | | | | | | | | | | | |
| ARMIN 2C (*4) | | | | | | | | | | | 1.0 | 1.0 | | | | | |
| ARMIN CD (*5) | | | | | | | | | | | | | 0.5 | 0.5 | | | |
| TBAB (*6) | | | | | | | | | | | | | | | | | 1.0 |
| Phosphoric acid A (*7) | | 1.0 | 1.0 | 1.0 | 1.0 | | | 1.0 | 1.0 | | 1.0 | | 1.0 | | | | 1.0 |
| Phosphoric acid C (*8) | | | | | | 0.8 | | | | | | | | | | | |
| Phosphoric acid C (*9) | | | | | | | 0.7 | | | | | | | | | | |
| DDBSA (*10) | | | | | | | | | | | | | | | 1.0 | | |
| Formic acid | | | | | | | | | | | | | | | | 0.14 | |
| BYK-300 (*11) | | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Storage stability (sec./Fc#4) | | 40 | 39 | 43 | 41 | 38 | 42 | 40 | 38 | 60 | 40 | 48 | 40 | 50 | 42 | 49 | 50 |
| Electric resistance (MΩ) | | 2.5 | 2.5 | 2.5 | 2.5 | 2.5 | 2.5 | 2.5 | 2.5 | 2.0 | 3.0 | 3.0 | 3.0 | 3.0 | 1.5 | 2.0 | 0.5 |
| Xylene elution ratio (%) | | 0.1 | 0.2 | 0.1 | 0.1 | 0.1 | 0.1 | 0.3 | 0.5 | 0.1 | 10.0 | 5.6 | 10.0 | 6.2 | 8.5 | 0.1 | 0.1 |
| Coated surface smoothness | LW | 4.5 | 4.5 | 4.6 | 4.6 | 4.0 | 4.5 | 4.5 | 5.0 | 5.5 | 5.5 | 5.5 | 5.5 | 5.6 | 5.5 | 5.6 | 5.0 |
| (WAVE SCAN) | SW | 10.0 | 9.8 | 10.2 | 9.8 | 9.5 | 10.0 | 11.0 | 9.5 | 16.5 | 11.0 | 11.2 | 11.0 | 11.3 | 11.1 | 16.0 | 10.0 |

| | | | | | | | | | | | | | | | | |
|---|---|---|---|---|---|---|---|---|---|---|---|---|---|---|---|---|
| Yellowing resistance (Δb) | 0.5 | 0.4 | 0.7 | 0.5 | 0.2 | 0.5 | 0.5 | 0.5 | 0.7 | 2.8 | 3.0 | 1.8 | 2.9 | 0.8 | 0.7 | 0.7 |

1. A paint composition characterized by comprising (A) carboxyl group- and/or cyclic acid anhydride group-containing compound, (B) polyepoxide and (C) latent curing catalyst composed of (C-1) tertiary amine and (C-2) acidic phosphoric acid ester.

2. A paint composition according to claim 1, in which the carboxyl group- and/or cyclic acid anhydride group-containing compound (A) is selected from (A-1) polycarboxylic acid compound containing at least two carboxyl groups per molecule, (A-2) cyclic acid anhydride compound containing at least one cyclic acid anhydride group per molecule, and (A-3) carboxyl group-containing cyclic acid anhydride compound containing at least one each of carboxyl group and cyclic acid anhydride group per molecule.

3. A paint composition according to claim 1, in which the carboxyl group- and/or cyclic acid anhydride group-containing compound (A) is selected from vinyl type polycarboxylic acid resin and polyester type polycarboxylic acid resin.

4. A paint composition according to claim 1, in which the polyepoxide (B) is an acrylic resin having on an average about 2-50 epoxy groups per molecule.

5. A paint composition according to claim 1, in which the polyepoxide (B) has an epoxy group content within a range of 0.5-5.0 millimols/g.

6. A paint composition according to claim 1, in which the tertiary amine (C-1) is a compound represented by a general formula: R₁R₂R₃N, wherein R₁, R₂ and R₃ may be the same or different and each stands for optionally halogen- or hydroxyl group-substituted hydrocarbon group, provided that at least one of R₁, R₂ and R₃ is a hydrocarbon group having at least 8 carbon atoms.

7. A paint composition according to claim 6, in which the tertiary amine (C-1) comprises at least one kind of tertiary amine which is selected from methyldialkylamine and dimethylalkylamine whose alkyl moieties have at least 8 carbon atoms.

8. A paint composition according to claim 1, in which the acidic phosphoric acid ester (C-2) is selected from dibutyl phosphate, bis(ethylhexyl)phosphate and diphenyl phosphate.

9. A paint composition according to claim 1 which contains the carboxyl group- and/or cyclic acid anhydride group-containing compound (A) and polyepoxide (B) at such a ratio that the equivalent ratio of the former's carboxyl groups to the latter's epoxy groups falls within a range of 1:0.5-1:2.

10. A paint composition according to claim 1, in which the latent curing catalyst (C) contains 2-90 mass % of the tertiary amine (C-1) and 10-98 mass % of the acidic phosphoric acid ester (C-2), based on the combined amount of the tertiary amine (C-1) and acidic phosphoric acid ester (C-2).

11. A paint composition according to claim 1 which contains the latent curing catalyst (C) within a range of 0.1-10 mass parts, per 100 mass parts in total of the compound (A) and polyepoxide (B).

12. A method of forming a multilayer coating film by successively applying onto a coating object at least one layer of coloring base coating paint and at least one layer of clear coating paint, which is characterized by applying a paint composition according to claim 1 as the top layer clear coating paint.
